(19) United States
(12) Patent Application Publication
(10) Pub. No.: US 2024/0169426 A1
(43) Pub. Date: May 23, 2024

(54) DYNAMIC GUIDE FOR PRODUCT IDENTIFICATION

(71) Applicant: Wells Fargo Bank, N.A., San Francisco, CA (US)

(72) Inventors: Sol Betancourt, Dallas, TX (US); Srikant Iyer, Powell, OH (US); Kerry Kiker, Paradise, TX (US); Cynthia R. Martinez, San Diego, CA (US); Collin Mutchler, Woodbury, MN (US); Donna N. Patel, Charlotte, NC (US); Joseph Wolbeck, Lino Lakes, MN (US)

(21) Appl. No.: 18/056,361

(22) Filed: Nov. 17, 2022

(51) Int. Cl. G06Q 40/02

(52) U.S. Cl. CPC G06Q 40/025

(57) ABSTRACT

An example computer system for identifying products for funding a purchase or refinance of a property can include: one or more processors; and non-transitory computer-readable storage media encoding instructions which, when executed by the one or more processors, causes the computer system to: create an information engine programmed to access information about a user; create a goals engine programmed to define one or more goals of the user associated with the purchase or refinance of the property; create a third party information engine programmed to access credit information for the user; and create a product and pricing selection engine programmed to, using the information about the user, the one or more goals of the user, and the credit information for the user, select one or more of the products for funding the purchase or refinance of the property.

### BACKGROUND

The selection of the proper funding product to solve a customer's needs when purchasing or refinancing a property can be daunting. The process is typically very subjective and dependent upon the skills of the customer and the consultants helping the customer make the selection.

### SUMMARY

Examples provided herein are directed to a dynamic guide for identifying products for funding the purchase or refinance of a property.

According to one aspect, an example computer system for identifying products for funding a purchase or refinance of a property can include: one or more processors; and non-transitory computer-readable storage media encoding instructions which, when executed by the one or more processors, causes the computer system to: create an information engine programmed to access information about a user; create a goals engine programmed to define one or more goals of the user associated with the purchase or refinance of the property; create a third party information engine programmed to access credit information for the user; and create a product and pricing selection engine programmed to, using the information about the user, the one or more goals of the user, and the credit information for the user, select one or more of the products for funding the purchase or refinance of the property.

According to another aspect, an example method for identifying products for funding a purchase of a property can include: creating an information engine programmed to access information about a user; creating a goals engine programmed to define one or more goals of the user associated with the purchase of the property; creating a third party information engine programmed to access credit information for the user; and creating a product selection engine programmed to, using the information about the user, the one or more goals of the user, and the credit information for the user, select one or more of the products for funding the purchase of the property.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for identifying products for funding the purchase or refinance of a property.

FIG. 2 shows example logical components of a server device of the system of FIG. 1.

FIG. 3 shows an example graphical user interface generated by the server device of FIG. 2.

FIG. 4 shows another example graphical user interface generated by the server device of FIG. 2.

FIG. 5 shows another example graphical user interface generated by the server device of FIG. 2.

FIG. 6 shows another example graphical user interface generated by the server device of FIG. 2.

FIG. 7 shows another example graphical user interface generated by the server device of FIG. 2.

FIG. 8 shows another example graphical user interface generated by the server device of FIG. 2.

FIG. 9 shows example physical components of the server device of FIG. 2.

### DETAILED DESCRIPTION

This disclosure relates to a dynamic guide for identifying products for funding the purchase or refinance of a property. In alternative embodiments, the same principles can be applied to other types of loans, such as home equity lines of credit.

In the examples provided herein, the dynamic guide is programmed to capture information known about a customer while a consultant assists the customer with finding a financial product to fund the purchase or refinance of a property, such as a mortgage. The dynamic guide uses this information to develop one or more financial products that may be a good fit for the customer. The dynamic guide can provide a consistent technological approach for the consultant that is driven by the information known about the customer, as well as information gathered during a consultation between the customer and the consultant.

Although the terms “customer” and “consultant” are used as examples in this description, the terms should not be construed as limiting. For instance, the customer can be any individual who is interested in obtaining a financial product to assist in the purchase or refinance of a property. Likewise, the consultant can be any individual who can assist the customer in identifying the financial product. Many scenarios are possible.

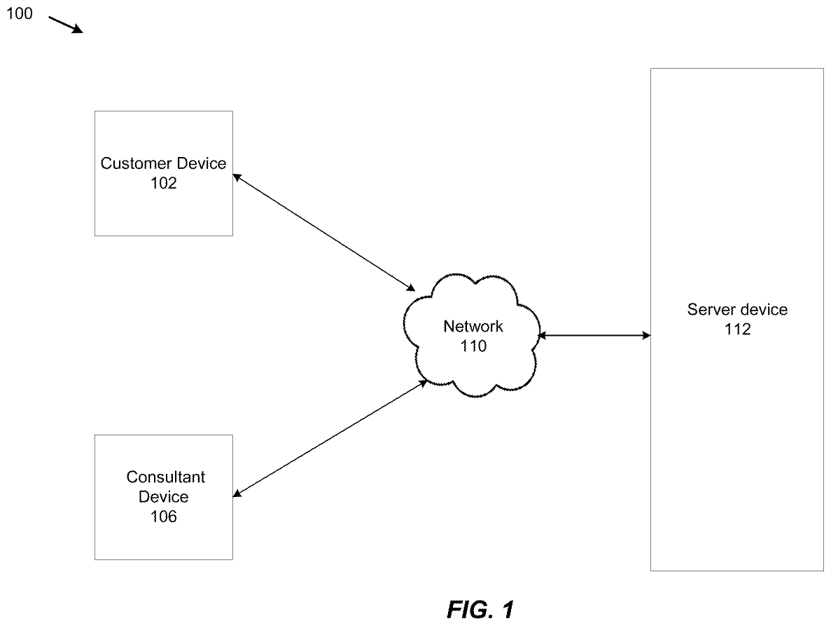

FIG. 1 schematically shows aspects of one example system 100 programmed to provide the dynamic guide. In this example, the system 100 can be a computing environment that includes a plurality of client and server devices. In this instance, the system 100 includes a customer device 102, a consultant device 106, and a server device 112. The customer device 102 and the consultant device 106 communicate with one another and the server device 112 through a network 110 to accomplish the functionality described herein.

Each of the client and server devices may be implemented as one or more computing devices with at least one processor and memory. Example computing devices include a mobile computer, a desktop computer, a server computer, or other computing device or devices such as a server farm or cloud computing used to generate or receive data.

The customer device 102 is programmed to allow the customer to search for, or otherwise request, a financial product for funding or refinancing the purchase or refinance of a property. In such examples, the customer could use the customer device 102 to search for properties, along with searching for a mortgage to purchase the properties. This can include, without limitation, working with another entity to assist in the selection of the mortgage, such as the consultant.

For instance, the customer device 102 may be programmed to support communication between the customer and the consultant through a secure session within a financial institution's (e.g., bank's) mobile application or website. For instance, the customer device 102 may be programmed to permit the customer to communicate with the consultant using an integrated system of messaging (e.g., chat box) within the mobile application or website. In some particular examples, the communication may begin or initiate with one or more automated prompts or a chatbot conversation to ensure that the customer is directed to the appropriate consultant. The customer device 102 may also (or alternatively) programmed to request that a consultant contact the customer (e.g., get a call back).

Although the depicted example shows the customer communicating with the consultant using the customer device 102, the customer can use many different ways to communicate with the consultant. For instance, the customer can instead communicate with the consultant through the telephone rather than a computing device (or use the computing device as a telephone). In yet another example, the customer can meet with the consultant face-to-face for communications. Many variations are possible.

The consultant device 106 is programmed to provide the dynamic guide to the consultant to assist the consultant in identifying one or more products for the customer. In these examples, the dynamic guide is programmed to access information about the customer from the customer device 102 and the server device 112. This information is used by the dynamic guide, as described further below, to provide a technology-driven, consistent approach to identifying possible financial products that would serve the needs of the customer.

The server device 112 is programmed to provide information about the customer and financial products to the consultant (and in some examples, consultants,) using the consultant device 106. In some examples, the server device 112 is implemented as a server farm or implemented in a cloud computing environment. That is, the server device 112 may be implemented as a set of hosted servers (e.g., pooled, centralized server resources), along with the corresponding executed applications, which are accessible and delivered over a network (e.g., the internet). A cloud environment offers the benefits of on-demand computing system resources, among other advantages. The server device 112 can be programmed to access one or more databases and/or third party entities to provide the information. For instance, the server device 112 can communicate with one or more credit reporting agencies to access credit information for the customer, as described further below.

In some examples, the server device 112 is owned by a financial institution, such as a bank. The consultant can be an employee or resource of the financial institution who can assist the customer with identifying one or more products of the financial institution. Or, the consultant can be an independent third party (e.g., licensed loan officer) who works with the financial institution to help identify one or more products of the financial institution for the customer. Similarly, the customer may be a customer (or a prospective customer) of the consultant and/or the financial institution. Finally, in some examples, the customer could perform some or all the functionality provided by the consultant.

In these examples, the customer is searching for a mortgage to fund the purchase or refinance of a property. The consultant can assist the customer with identifying mortgage products that will fit at least the customer's current situation and goals. In some examples, this may also include the customer's future goals. The financial institution can provide one or more software applications that receive information about the customer and the customer's goals, obtain information from third parties about the customer, and identify those mortgage products that would optimally meet the customer's current situation and goals.

The network 110 provides a wired and/or wireless connection between the customer device 102, the consultant device 106, and the server device 112. In some examples, the network 110 can be a local area network, a wide area network, the Internet, or a mixture thereof. Many different communication protocols can be used. Although only three devices are shown, the system 100 can accommodate hundreds, thousands, or more of customers and consultant devices.

The technology described herein results in the technical solution of providing a repeatable, consistent process for identifying the optimal products for the customer. Moreover, the technology described herein provides an important improvement through an objective technical solution. That is, a technical solution is provided that removes subjective variables, and provides objective determinations, and therefore, reduces the need to compensate for variations (e.g., variations between customers, products, etc.).

For instance, the technology solution may provide a technical benefit by removing implicit biases that result from subjective determinations and/or assumptions that a consultant historically has needed to make when selecting a product for a customer. Further, the user interfaces result in an ordered combination of elements that has the practical application of displaying the products in a more intuitive and efficient manner. These and other advantages are described further below.

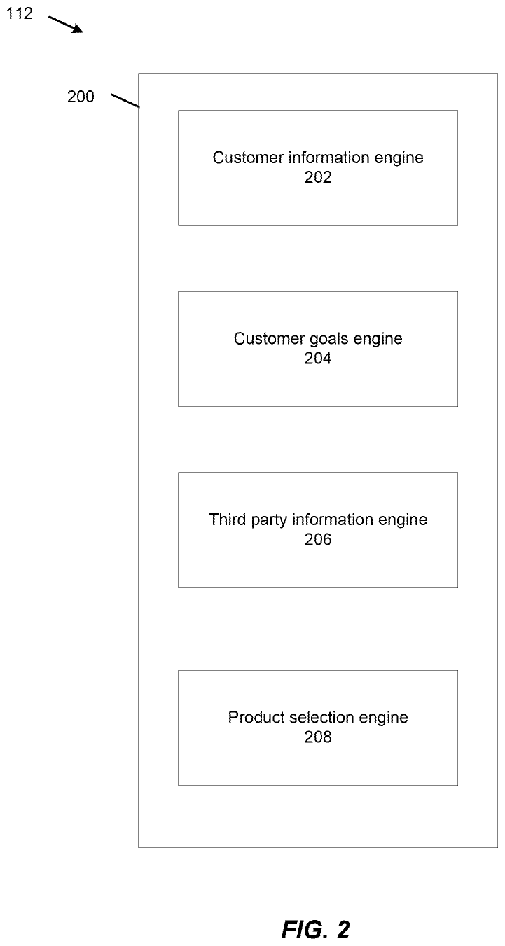

Referring now to FIG. 2, additional details of the server device 112 are shown. In this example, the server device 112 provides a software application 200 having logical modules that assist the consultant with identifying the optimal product(s) for funding the purchase or refinance of a property for the customer. The server device 112 can include a customer information engine 202, a customer goals engine 204, a third party information engine 206, and a product and pricing selection engine 208. The consultant can use the consultant device 106 to communicate with the server device 112 to access this functionality.

The customer information engine 202 of the software application 200 is programmed to access information known about the customer. This information can come from a variety of sources. For instance, the customer can provide the information, such as by inputting the information into the customer device 102 and/or providing the information to the consultant for entry on the consultant device 106. This can include such information as the customer's name, current address, etc.

In addition, when the customer is already a customer of the financial institution, the customer information can also be obtained through information held by the financial institution. Such information can include, for example, the specifics of any current loans (e.g., an existing loan on the property), current assets (e.g., amounts in checking and savings accounts), etc.

Further, the information can be obtained by the customer information engine 202 from one or more third parties. For instance, as described further below, information about a credit score and liabilities can be obtained from a credit reporting agency using the third party information engine 206. Many other configurations are possible.

The customer goals engine 204 of the software application 200 is programmed to identify one or more goals associated with the customer. For instance, the customer may indicate the customer wishes to minimize certain aspects of the mortgage, such as the down payment or monthly payment amount. The customer can provide this information using the customer device 102 and/or the consultant can capture this information using the consultant device 106. The customer goals engine 204 captures this information for use by the software application 200 when selecting products for the customer.

The third party information engine 206 of the software application 200 is programmed to obtain information about the customer from one or more third parties. For instance, the third party information engine 206 can be programmed to obtain consent from the customer to perform a soft credit pull from a credit reporting agency. This soft credit pull can provide the software application 200 with credit information about the customer so that the proper product(s) can be selected by the software application 200 for the customer.

The product and pricing selection engine 208 of the software application 200 is programmed to use the information from the customer information engine 202, the customer goals engine 204, and the third party information engine 206 to select the product or products that will be the optimal fit for the customer. These product(s) can be returned to the consultant on the consultant device 106 for presentation to the customer. In an alternative embodiment, the product(s) can be returned directly to the customer. Many configurations are possible.

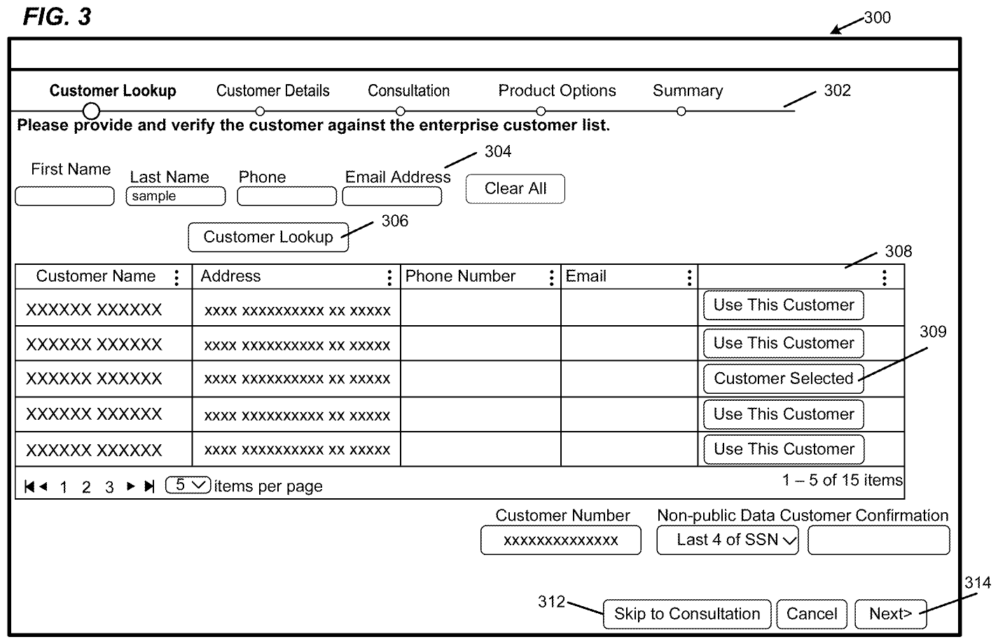

Referring now to FIGS. 3-8, example graphical user interfaces are shown as generated by the software application 200. In some examples, the graphical user interfaces can be generated by the software application 200 for rendering on the consultant device 106 for the consultant and/or on the customer device 102 for the customer. Generally, the interfaces provide a consistent, repeatable process for identifying optimal product(s) for funding the purchase or refinance of a property by the customer. FIGS. 3-8 are described with continuing reference to FIGS. 1 and 2.

At FIG. 3, an example interface 300 is presented to the consultant on the consultant device 106. The interface 300 includes a navigational bar 302 that indicates a position of the consultant in the process for identifying optimal product(s) for the customer. In FIGS. 3-8, the navigational bar 302 is illustrated as a bar having nodes positioned along a length thereof and positioned between terminal ends of the bar. The relative position of the nodes between the terminal ends corresponds to the different positions that a consultant may be at within the process. While shown as progressing from left (start) to right (end) (i.e., from the viewer's perspective of FIGS. 3-8), in various other examples other arrangements are possible.

In the illustrated examples, the particular position of the consultant within the process is indicated by denoting (e.g., boldening, coloring, highlighting, etc.) the corresponding node. For instance, in FIG. 3, the left-most (i.e., from the viewer's perspective of FIGS. 3-8) node is boldened to indicate that the particular position in the process is “Confirm Customer Info”. In some examples, this example navigational bar 302 can be provided throughout the example user interfaces of FIGS. 3-8.

In this example, the interface 300 is programmed to capture information about the customer by the customer information engine 202. The interface includes fields 304 for capturing bibliographic information about the customer, such as the customer's name, address, phone number, and email address. Some or all of this information can be pre-populated when the customer is pre-authenticated on the customer device 102 or otherwise provides the information. That is, information within interface 300 may be pre-populated from a system of record following a successful authentication of the customer (e.g., the customer logging-in with a username and password to an account at a financial institution via a mobile app or website).

A control 306 of the interface 300 is selectable to cause the software application 200 to lookup the customer based upon the customer's information from the fields 304. For instance, the customer's name, etc. can be used to query the information stores (e.g., system of record) of the financial institution to determine if the financial institution has information about the customer. For instance, the customer may have previously provided this information when registering for an online account, opening a financial account, applying for a loan, etc.

A table 308 of the interface 300 lists possible matches for the customer, based on the customer information entered in the fields 304. In the illustrated example, the possible matches are listed by name and corresponding address. However, in other examples, possible matches may be displayed in other easy to read/understand formats. The software application 200 can receive selection of a control 309, by the consultant, to select the correct customer (i.e., the possible match that corresponds to the correct customer). If the customer is not listed in the table 308 (e.g., if the customer is not a current customer of the financial institution), a control can be provided that allows the customer to be added to the system 100 as a “prospect” (also referred to as a prospective customer or prospect customer). Alternatively, a control 312 allows the consultant to continue without adding the customer to the system 100.

Finally, upon receipt of selection of a control 314, the interface 300 transitions to another interface for obtaining the goals of the customer. Other controls, such as to cancel or move back (e.g., a step or more) in the process, can also be provided on each interface. As noted, the navigational bar 302 reflects the current point in the process as the interfaces cycle forward or backward in the process for identifying optimal product(s) for the customer.

Notably, the navigational bar 302, and (more generally) the interfaces discussed herein, provide a streamlined and organized (e.g., minimalized) arrangement of controls, information, and visualizations. Such a configuration provides a technical advantage in that the organized interfaces may load faster (reducing customer wait time), require fewer resources, and bring a clearer impression to the user (i.e., the consultant). This is an important advantage when providing a repeatable and consistent process for identifying the optimal product(s) for the customer.

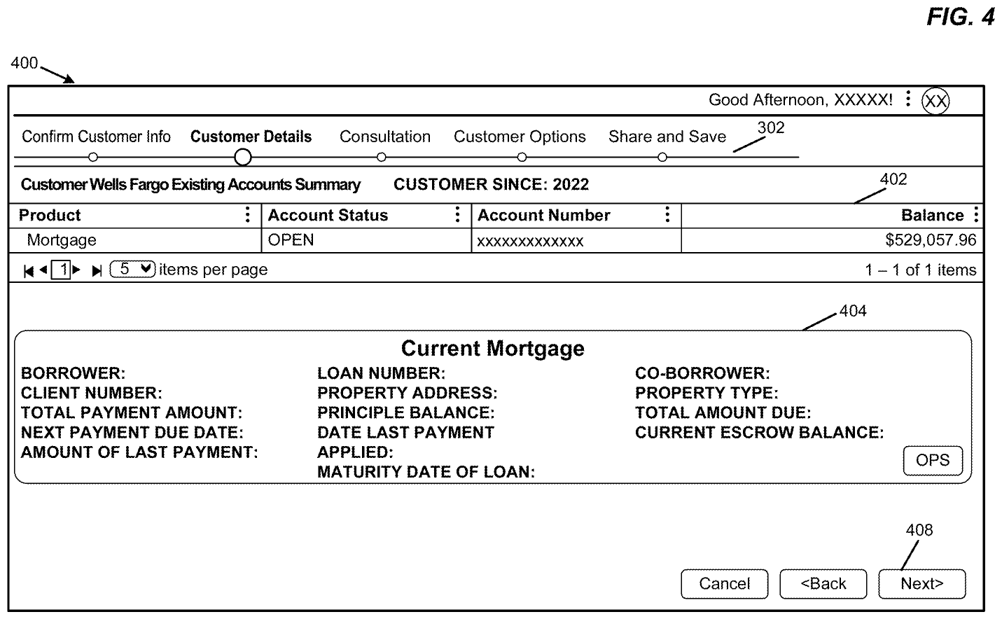

Referring now to FIG. 4, an example interface 400 of the software application 200 is shown. The interface 400 is programmed to capture information about the customer by the customer goals engine 204.

The interface 400 includes a summary table 402 that lists accounts held by the customer. For instance, when the customer is a customer of the financial institution, the account information can be obtained from the data stores (e.g., system of record) of the financial institution, and listed on the summary table 402. In the example shown, accounts including an existing mortgage and checking/saving accounts are shown. Information including account type, account number, account status, balance, etc. for each account can also be listed on the summary table 402. In various other examples, the summary table 402 may include other account information, such as investment accounts, retirement accounts, and trust funds, just to name a few examples.

The interface 400 also includes a section 404 listing additional details about accounts that are specifically relevant to the customer's inquiry for a financial product, such as existing mortgages in this instance. Information about the account that is specifically relevant (e.g., the mortgage), such as amount, payments, due dates, escrow balances, maturity date, etc., can be listed in the section 404. Finally, upon receipt of selection of a control 408, the interface 400 transitions to an interface for obtaining information about the customer from third party sources.

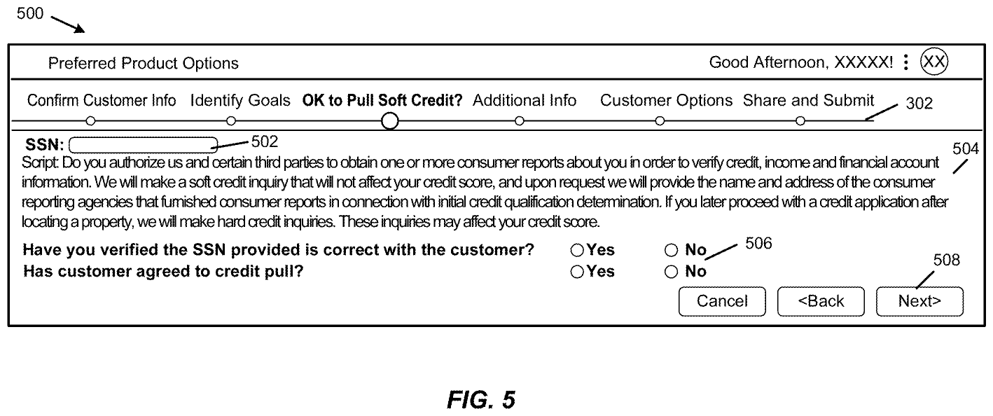

Referring now to FIG. 5, an example interface 500 of the software application 200 is shown. The interface 500 is programmed to initiate capture of information from one or more third parties about the customer by the third party information engine 206.

The interface 500 includes a field 502 for capturing information specific to the customer. In this instance, the field 502 captures a social security number of the customer. However, in other examples, other identifying information may be captured, such as date of birth. The social security number can be used along with other information about the customer to obtain credit information for the customer.

In this instance, the interface 500 also includes information 504 for the customer about consent to obtain the credit information. For instance, the consultant can read, message, or otherwise convey the information 504 to the customer to obtain consent for authorizing the consultant (or corresponding financial institution) to request and obtain the information from the one or more third parties. Further, the interface 500 includes controls 506 that confirm that the customer's consent is obtained. In this example, the controls 506 include verification of the customer's social security number and consent by the customer to obtain the credit information.

In this example, the credit information is obtained from a third party entity such as a credit reporting agency. This can be done using a soft credit check, which involves obtaining credit information from a credit reporting agency without impacting the credit score of the customer. Many other configurations are possible. For instance, in other examples, a hard credit check can be done. In still other examples, multiple third parties may be queried for customer information. For instance, a soft credit check may be performed at multiple credit reporting agencies. Once the customer data needed to request the soft credit and consent is obtained, and upon receipt of selection of a control 508, the interface 500 transitions to an interface for obtaining additional information about the customer.

Alternatively, this information can be sent directly to the customer device 102 for approval by the customer. For instance, the customer can be provided with a passcode, and that passcode can be provided by the customer as the authorization to pull the credit report. Many configurations are possible.

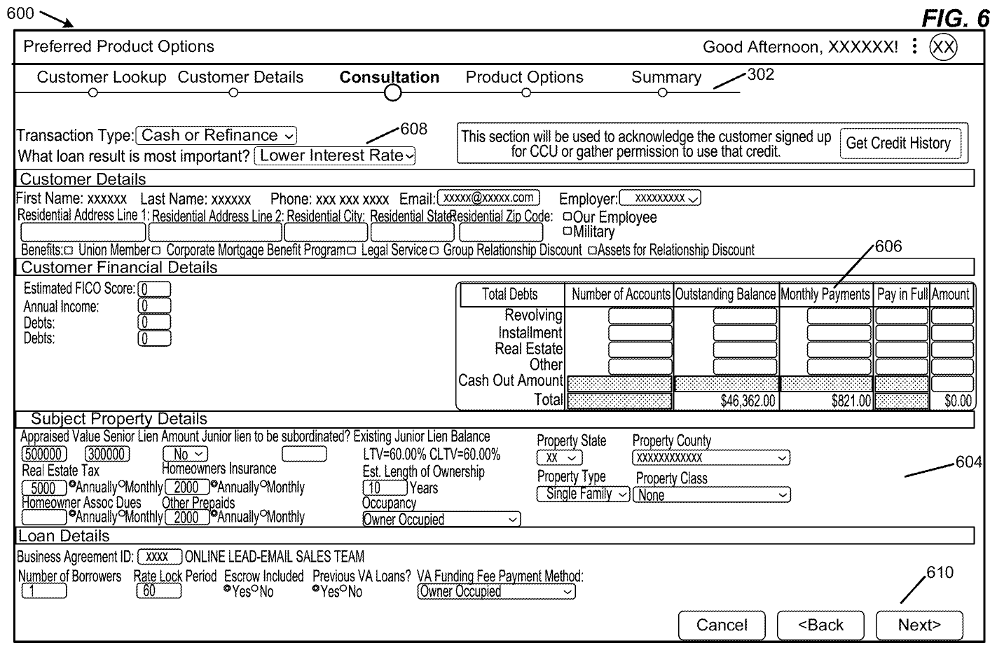

Referring now to FIG. 6, an example interface 600 of the software application 200 is shown. The interface 600 is programmed to capture additional information about the customer that may be relevant to identifying the optimal financial product for the customer.

Further, the example interface 600 includes a section 604 to obtain information about the desired property to be purchased (or refinanced). In this example, information relevant to the potential transaction is captured, such as the value, property type, county and state, taxes, insurance, etc. In some instances, the information in the section 604 can be auto-populated or partially auto-populated. That is, information that is locally available, or available from one or more third party sources, may be auto-populated, while missing information is not. Information in section 604 may be requested/obtained from third party sources, such as a multiple listing service.

In other examples, the example interface 600 can include additional sections to obtain employment and credit information about the customer. For instance, the consultant can determine if the customer is a member of a union or the military, and the section can be used to capture this information, along with an employer name which can identify special benefits the customer may be eligible for. Further, if a credit score is not obtained by a soft credit check, the estimated credit score for the customer can be captured in the section.

In other examples, this information may be auto-populated from the data stores of the financial information (e.g., financial institution's system of record) if the customer has an existing mortgage account with the financial institution. In still other examples, this information may be auto-populated based on information received from another lending institution, affiliate, government entity, or insurance provider, to name a few examples.

The example interface 600 can include a table 606 summarizing the consumer debt associated with the customer. The table 606 can include the summary information for each type of debt (e.g., revolving, installment, real estate), along with information associated with the debt, such as debt holder, balance, monthly payment, etc.

In some instances, the interface 600 can also list the specific accounts associated with teach type of debt. For instance, a table can be provided that lists a credit card held by the customer, along with the balance and estimated monthly payment. Each debt corresponds to a row, with the information associated with the debt filling each column within that row (e.g., a respective row for debt holder, balance, monthly payment, etc.). Additional debts may be listed as additional rows, with corresponding columns. The consultant can also use this worksheet to capture additional cash-out the customer requests to be included in the total cash-out amount.

In such an example, the table can include a second row corresponding to a secured loan, a third row corresponding to a credit card, a fourth row corresponding to a credit card, etc. Additional information about the debt held by the customer can be added by the consultant to the table by selection of an “add row” control. Upon selection of the add row control, a new row may populate with corresponding fields for the consultant to enter/edit the information associated with added debt.

In various examples, the table can further include one or more total calculations for the debts. For instance, the table can include a determination of the total balance, total estimated monthly payment, and total payoff amount. These calculations may be displayed in an easily-understood banner or row (e.g., at the bottom of the table). The total calculations may be based on a summation of the corresponding information for each of the debts listed in the table.

In some examples, the table may include a payoff control for each of the debts listed in the table. The payoff controls for each of the debts can be illustrated as a corresponding selectable radio button. Each payoff control is selectable to control which debts (and debt information) are included in the summation for the total payoff amount.

Finally, the interface 600 includes a goals section 608 that receives one or more goals of the customer as captured by the consultant. For instance, the goals section 608 can include dropdown lists that receive selection by the consultant to indicate certain goals of the customer, such as obtaining a lower interest rate and/or a lower monthly payment. The goals section 608 can also, in some alternatives, include a text entry section that allows for free-form capture of the customer's goals, such as using money saved on the mortgage to buy a boat. Many configurations are possible.

Once the relevant information about the customer is captured (as appropriate), upon receipt of selection of a control 610, the interface 600 transitions to providing information about the possible financial products available for the customer.

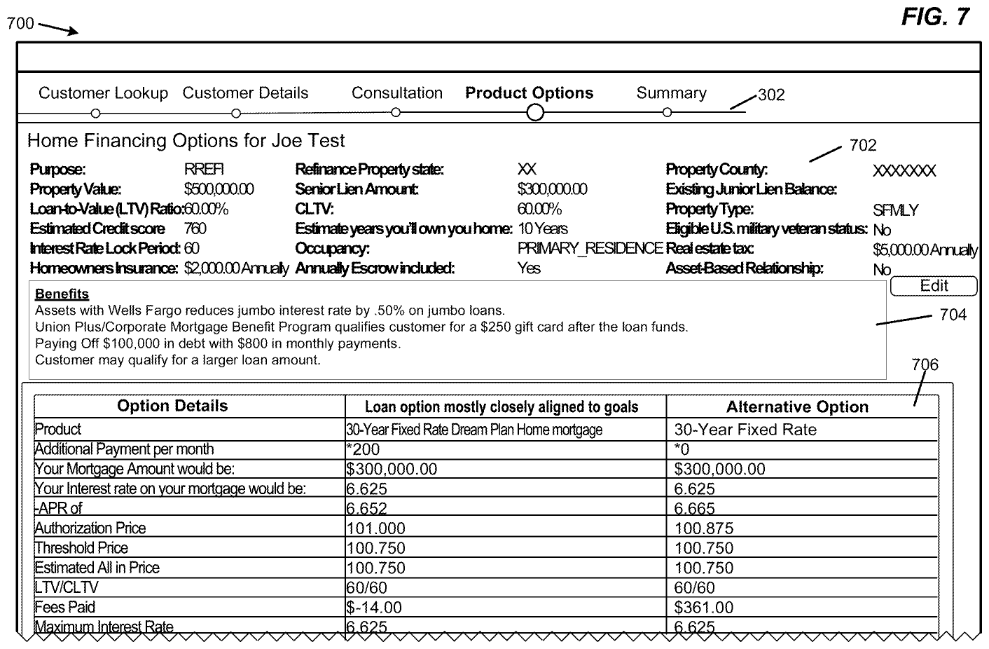

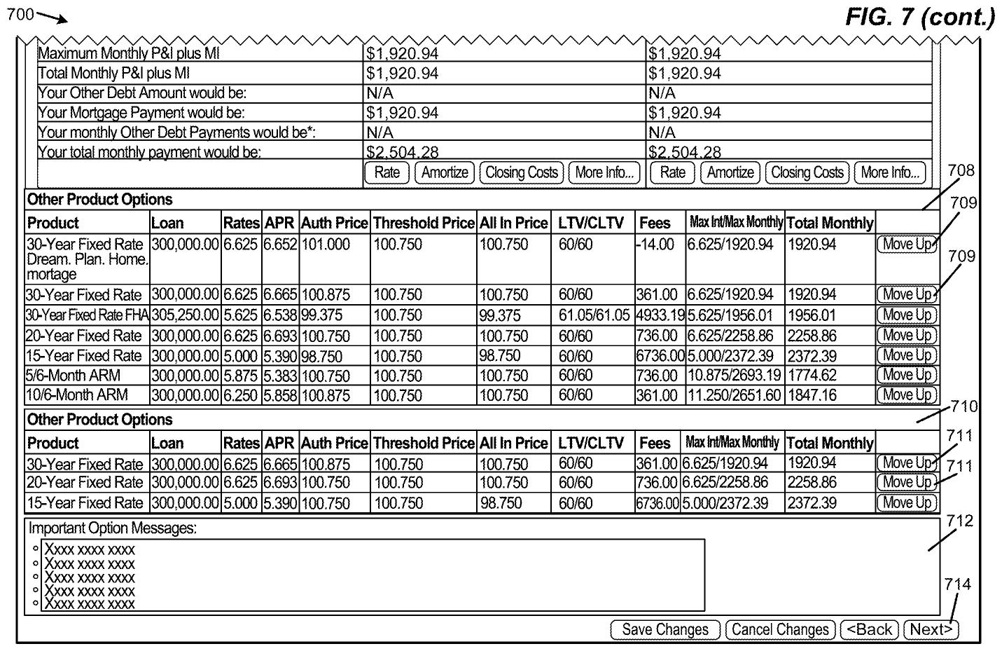

Referring now to FIG. 7, an example interface 700 of the software application 200 is shown. This interface 700 provides information about the options for the financial products that are available for the customer.

A pane 702 of the interface 700 provides a summary of the information used by the software application 200 to arrive at the financial products listed on the interface 700. As previously noted, that information can include information from the customer, information from the internal data stores of the financial institution, and/or information from third parties like credit reporting agencies.

In this example, the pane 702 provides such information as the specifics of the selected optimal product for the customer, such as loan type (e.g., purchase or refinance), loan amount, etc. The pane 702 also includes other information used to arrive at the selected products, such as property type, occupancy, goals, number of years to own home, veteran status, etc. If necessary, the pane 702 allows the information to be edited for corrections.

An example box 704 of the interface 700 lists potential benefits of selecting the optimal product that is best suited for the customer. The example box 704 provides a short description of the potential benefits, which can be easily read, and conveyed by the consultant to the customer. While shown as a short list of benefits in FIG. 7, in various other examples the benefits may be displayed in various other easily-understood arrangements. The benefits listed in the box 704 can be customized based on the customer and loan options. As discussed, these benefits can be conveyed by the consultant to the customer. Such benefits can include the reason for selecting a certain type of loan over another, or exclusive benefits offered through the financial institution, etc. The benefits can also extend to paying off other debts in conjunction with the financial product used to fund the property. For example, FIG. 7 shows the box 704 including benefits related to reducing interest rate, qualification for gift cards, paying off debt with certain payment amounts, and qualification for a larger loan amount. These are just a few examples, and in other examples the benefits are specific to the particular customer and product.

The benefits listed in the box 704 can change as different products are selected by the consultant (e.g., the consultant switches between the optimal product and alternative options). It is appreciated that certain alternative options may have benefits (relative to the optimal product) despite not being the optimal product. The box 704 may be used to summarize and convey these benefits (i.e., of the alternative option(s)) to the consultant. Notably, the example box 704 provides critical explanatory information about the selected financial product (and why it could be beneficial to the customer) automatically and in an easily identifiable and understandable manner. Such a configuration is an important advantage when providing a repeatable and consistent process for identifying the optimal product(s) for the customer.

The benefits listed in the box 704 can be modified as the consultant switches between the selected products. For instance, as a different selected product selection is received, the benefits listed in the box 704 can be updated to reflect those benefits associated with the new selected product.

An example table 706 of the interface 700 displays more details about the selected financial product that best-fits the customer's desired loan result (e.g., for instance, lowest payment, shortest repayment period, etc.) (i.e., the optimal product). The table 706 lists such information as the monthly payment amount, maturity date, term, annual percentage rate, etc.

In addition, the table 706 provides an option for the consultant to select an alternative product for display along-side the selected product. That is, the table 706 is configured to display at least a second (alternative) product (and the corresponding information) along-side the selected product to facilitate a side-by-side comparison of the features of each of the products.

In this example, the selected product is a 30-year fixed term loan, and the alternative product is a 5/6-month adjustable-rate mortgage. Each of the products corresponds to a column in the table 706, with the information corresponding to each product displayed in rows (e.g., monthly payment row, total monthly payment difference row, term row, APR row, etc.). This allows the consultant to readily compare the selected and alternative options for the customer.

In addition, in some alternative embodiments, a drop-down menu can provide list of selectable alternative options for selection by the consultant for display in the table 706. That is, the drop-down menu may include all of the product options that are alternatives to the selected product. Selection of the drop-down menu, and a particular alternative product option within the drop-down menu, prompts the table 706 to update with the side-by-side comparison between the selected product and the particular alternative option. The table 706 may update in real-time in response to selection of different alternative options, facilitating an experience where multiple alternative products can be compared to the selected (e.g., optimal) product.

In an alternative example, if the transaction is a refinance, key elements of the existing mortgage can be compared against the proposed new loan options.

An example table 708 of the interface 700 provides a list of other alternative products for the customer. Information about each, such as loan amount, rate, etc., is provided. The consultant can then select from these alternatives and move them up or down (i.e., within the orientation of the table 708 and relative to the other listed alternatives) (upon receipt of selection of a control 709) to compare against the optimal product for the customer, which in this instance is the loan that most aligns with the customer's goals (e.g., lowest monthly payment, shortest repayment period). In addition to the high-level loan details (amount, APR, payment, etc.), certain details/benefits can be displayed and can recalculate as loan options move up and down. For instance, the monthly payment of the new versus current loan may be recalculated as the loan options move up and down. Once the consultant and/or the customer identify the options the customer is most interested in, a product comparison can be generated and provided to the customer, as described further below. The consultant can also, in some instances, select the products and make updates to specific scenarios, such as add discounts points, to customize the results even further.

An example table 710 of the interface 700 provides another list of alternative products for the customer. In this embodiment, the table 710 lists the maximum loan amounts for which the customer may be eligible. For instance, the maximum loan amounts for various products (e.g., 30-year fixed, 20-year fixed, and 15-year fixed) are provided to allow the customer to understand his, her, or their potential ‘buying power’. Again, the order for the table 710 is changeable by the consultant upon selection of controls 711. In various examples, the alternative products listed in table 708 and table 710 may be displayed based on determining that the customer is eligible for the products. As discussed herein, in various examples these determinations are based on the customer information (e.g., which may be accessed or obtained by the customer information engine 202), goals, and/or third party information.

An example notice pane 712 of the interface 700 provides any notices associated with the products listed in the interface 700. For instance, the notice pane 712 can provide the consultant and/or the customer with reminders and disclosures that are dynamic and based on the customer's profile and products options listed on the interface 700. Examples of such notices include an indication that one or more of the rate lock periods is different from the one requested by the consultant. Another example is notices of the requirements to qualify for certain loan products.

Upon receipt of selection of a control 714, the interface 700 transitions to an interface for providing options for sharing the information about the financial products.

The example interface 700 can be advantageous for several reasons. For example, the interface 700 represents the culmination of the collection and processing of the information associated with the customer. This process is preferably a consistent, repeatable process that provides better outcomes for the consultant and the customer. Further, the interface 700 provides the practical application of showing necessary information to the consultant and/or the customer in a more efficient manner. Specifically, the interface 700 provides all the relevant information necessary for the consultant to provide meaningful counsel to the customer for selection of a product. Many other advantages are possible.

In an alternative embodiment, the interface 700 (or a separate interface) can also include additional information from the soft credit pull. As noted above, the credit score from a soft credit pull for the customer can provide more accurate product and pricing options.

In an alternative example, the system 100 can, from the soft credit pull, display an aggregated liability (e.g., revolving, installment, real estate, other) worksheet with various information. This information can include a number of accounts, total balance and monthly payment, for a comprehensive picture of the customer's existing monthly obligations and aid in the debt consolidation discussion. One non-limiting example of such a display is provided in the following table or worksheet.

| | Number of | Outstanding | Monthly | Pay In | Payoff |
|---|---|---|---|---|---|
| Total Debts | Accounts | Balance | Payments | Full | Amount |
| Revolving | 3 | $7,500 | $150 | | $5,000 |
| Installment | 2 | $10,000 | $350 | X | |
| Real Estate | 1 | $375,000 | $1,727 | | |
| Other | 1 | $1,000 | $25 | X | |

For instance, in one example, such a table could be incorporated into the interface 700, such as between the table 710 and the notice pane 712. Many other configurations are possible.

This example table can help to facilitate the debt consolidation discussion and the data captured here, including a row to capture additional cash-out amount, translates to the total cash-out used to determine product and pricing options. This table can be edited if the customer wants to consolidate more or less debts or get more or less cash-out. The data in the table can be automatically populated from the soft credit report or can be manually added.

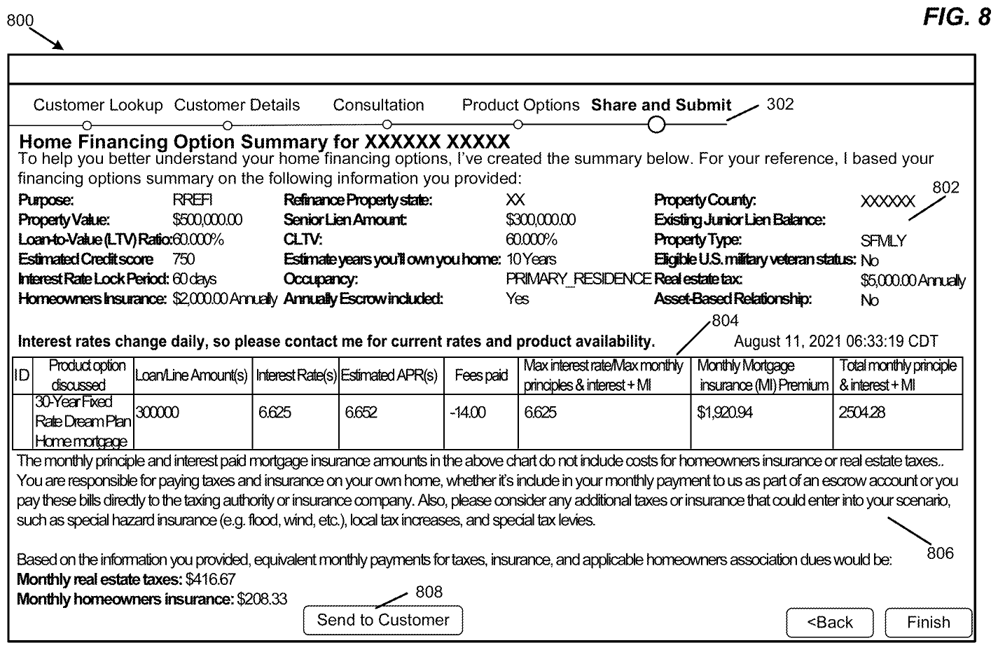

Referring now to FIG. 8, an example interface 800 of the software application 200 is shown. This interface 800 provides information about one or more of the selected products for the customer, in certain examples, the selected product may be the optimal product for the customer determined based on at least the customer information, goals, and/or third party information.

In this example, a section 802 of the interface 800 includes a summary of the information used to determine the loan options and pricing for the customer. Such information as property value, insurance, occupancy type, etc., can be shown so that the customer better understands the assumptions that are used to select the product(s).

The example interface 800 could also include the existing loan being refinanced to compare against. In such an example, special benefits or selected loan program(s) for which the customer may be eligible can be recapped.

The interface 800 also includes a table 804 that lists the selected financial product or products. In this example, the table 804 provides the type of loan, amount, interest rate, fees, monthly payment amount (principal plus interest), etc. This allows the customer to understand the specifics of the product.

A section 806 of the interface 800 includes additional details relating to other aspects of the financial product and possible additional costs. These include costs associated with real estate taxes and property insurance. Finally, a control 808 is selectable by the consultant and/or the customer to send the information to the customer, such as by email, instant message, etc. Many configurations are possible.

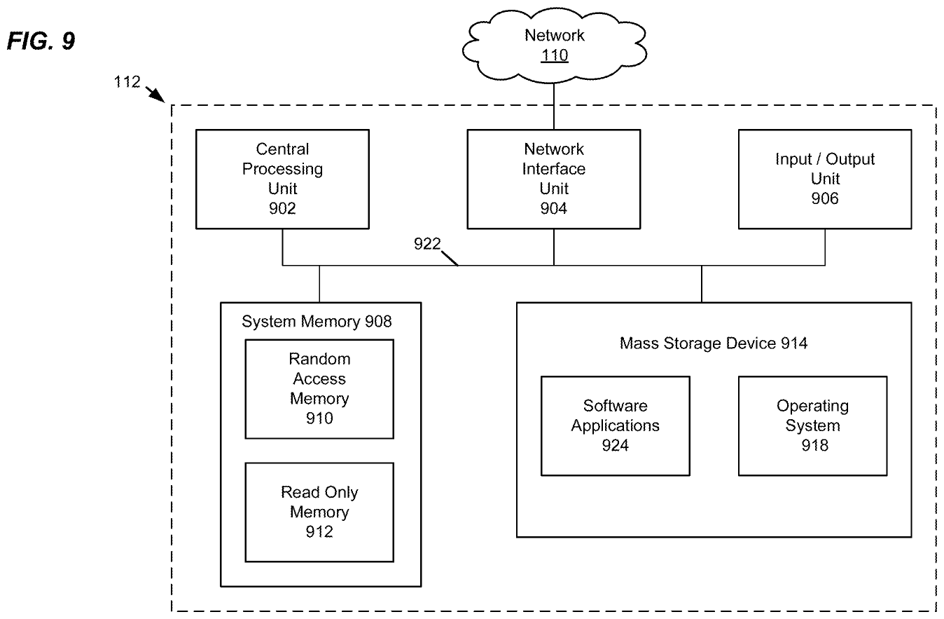

As illustrated in the embodiment of FIG. 9, the example server device 112 which provides the functionality described herein can include at least one central processing unit (“CPU”) 902, a system memory 908, and a system bus 922 that couples the system memory 908 to the CPU 902. The system memory 908 includes a random access memory (“RAM”) 910 and a read-only memory (“ROM”) 912. A basic input/output system containing the basic routines that help transfer information between elements within the server device 112, such as during startup, is stored in the ROM 912. The server device 112 further includes a mass storage device 914. The mass storage device 914 can store software instructions and data. A central processing unit, system memory, and mass storage device similar to that shown can also be included in the other computing devices disclosed herein.

The mass storage device 914 is connected to the CPU 902 through a mass storage controller (not shown) connected to the system bus 922. The mass storage device 914 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 904 connected to the system bus 922. It should be appreciated that the network interface unit 904 may also be utilized to connect to other types of networks and remote computing systems. The server device 112 also includes an input/output controller 906 for receiving and processing input from a number of other devices, including a touch user interface display screen or another type of input device. Similarly, the input/output controller 906 may provide output to a touch user interface display screen or other output devices.

As mentioned briefly above, the mass storage device 914 and the RAM 910 of the server device 112 can store software instructions and data. The software instructions include an operating system 918 suitable for controlling the operation of the server device 112. The mass storage device 914 and/or the RAM 910 also store software instructions and applications 924, that when executed by the CPU 902, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for identifying products for funding a purchase or refinance of a property, comprising:
one or more processors; and
non-transitory computer-readable storage media encoding instructions which, when executed by the one or more processors, causes the computer system to:
create an information engine programmed to access information about a user;
create a goals engine programmed to define one or more goals of the user associated with the purchase or refinance of the property;
create a third party information engine programmed to access credit information for the user; and
create a product and pricing selection engine programmed to, using the information about the user, the one or more goals of the user, and the credit information for the user, select one or more of the products for funding the purchase or refinance of the property.

2. The computer system of claim 1, wherein the user is a customer of a financial institution.

3. The computer system of claim 1, wherein the information engine is further programmed to access financial information about the user from a financial institution.

4. The computer system of claim 3, wherein the financial information relates to one or more accounts held by the financial institution.

5. The computer system of claim 1, wherein the third party information engine is further programmed to conduct a soft credit pull for the user.

6. The computer system of claim 1, wherein the product and pricing selection engine is further programmed to generate a user interface including:
a first view programmed to capture the information about the user for the information engine;
a second view programmed to define the one or more goals for the goals engine;
a third view programmed to receive authorization for a soft credit pull for the third party information engine; and
a fourth view programmed to present the products by the product and pricing selection engine.

7. The computer system of claim 6, wherein the fourth view includes:
a box listing benefits for the user associated with one or more selected products of the products;
a first table listing aspects of one or more selected products;
a second table listing alternative products to the one or more selected products of the products; and
a third table listing a maximum product associated with a maximum loan amount for the user.

8. The computer system of claim 1, wherein the product and pricing selection engine is further programmed to generate a user interface including one or more selected products of the products for the user, the user interface including loan information about the one or more selected products and providing benefits for a customer associated with the one or more selected products.

9. The computer system of claim 8, wherein the user interface further includes an alternative product, wherein the alternative product is selectable by the user.

10. The computer system of claim 8, wherein the user interface further includes:
a box listing benefits for the user associated with the one or more selected products of the products;
a first table listing a plurality of alternative products to the one or more selected products of the products, wherein a first order among the plurality of alternative products is movable; and
a second table listing a plurality of maximum products associated with maximum loan amounts for the user, wherein a second order among the plurality of maximum products is movable.

11. A method for identifying products for funding a purchase of a property, comprising:
creating an information engine programmed to access information about a user;
creating a goals engine programmed to define one or more goals of the user associated with the purchase of the property;
creating a third party information engine programmed to access credit information for the user; and
creating a product selection engine programmed to, using the information about the user, the one or more goals of the user, and the credit information for the user, select one or more of the products for funding the purchase of the property.

12. The method of claim 11, wherein the user is a customer of a financial institution.

13. The method of claim 11, wherein the information engine is further programmed to access financial information about the user from a financial institution.

14. The method of claim 13, wherein the financial information relates to one or more accounts held by the financial institution.

15. The method of claim 11, wherein the third party information engine is further programmed to conduct a soft credit pull for the user.

16. The method of claim 11, wherein the product selection engine is further programmed to generate a user interface including:
a first view programmed to capture the information about the user for the information engine;
a second view programmed to define the one or more goals for the goals engine;
a third view programmed to receive authorization for a soft credit pull for the third party information engine; and
a fourth view programmed to present the products by the product selection engine.

17. The method of claim 16, wherein the fourth view includes:
a listing of benefits for the user associated with one or more selected products of the products;
a first table listing aspects of the one or more selected products;
a second table listing alternative products to the one or more selected products of the products; and
a third table listing a maximum product associated with a maximum loan amount for the user.

18. The method of claim 11, wherein the product selection engine is further programmed to generate a user interface including one or more selected products for the user, the user interface including loan information about the one or more selected products.

19. The method of claim 18, wherein the user interface further includes an alternative product to the one or more selected products, wherein the alternative product is selectable by the user.

20. The method of claim 18, wherein the user interface further includes:
a box listing benefits for the user associated with the one or more selected products of the products;
a first table listing alternative products to the one or more selected products of the products, wherein a first order among the alternative products is movable; and
a second table listing maximum products associated with maximum loan amounts for the user, wherein a second order among the maximum products is movable.
